(19) United States
(12) Patent Application Publication
(10) Pub. No.: US 2026/0326455 A1
(43) Pub. Date: Oct. 22, 2026

(54) DEAERATION MODULE AND INKJET RECORDING APPARATUS

(71) Applicant: Konica Minolta, Inc., Tokyo (JP)

(72) Inventors: Eiji TABATA, Tokyo (JP); Hiroshi SHIBATA, Tokyo (JP); Mai NAGANO, Tokyo (JP)

(21) Appl. No.: 19/649,338

(22) Filed: Apr. 16, 2026

(30) Foreign Application Priority Data
Apr. 18, 2025 (JP) 2025-068519

(51) Int. Cl. B41J 2/19; B41J 2/175; B41J 2/18; B41J 2/20; B41J 29/377; C09D 11/30

(52) U.S. Cl. CPC B41J 2/19; B41J 2/175; B41J 2/18; B41J 2/20; B41J 29/377; C09D 11/30

(57) ABSTRACT

A deaeration module includes a gas permeable membrane that selectively permeates a gas dissolved in ink. The ratio of the inner diameter of the gas permeable membrane to the membrane thickness of the gas permeable membrane is 3.2 or less. The deaeration module removes the gas dissolved in the ink by an external recirculation method.

### CROSS-REFERENCE TO RELATED APPLICATIONS

The entire disclosure of Japanese Patent Application No. 2025-068519 filed on Apr. 18, 2025, is incorporated herein by reference in its entirety.

### BACKGROUND OF THE INVENTION

### Technical Field

The present disclosure relates to a deaeration module and an inkjet recording apparatus.

### Description of Related Art

There is known an ink ejection apparatus that ejects ink from an ink ejection section onto a recording surface of a recording medium to record an image. When gases are dissolved in ink of the ink ejection apparatus, the gases cause a problem.

To remove dissolved gases in the ink, a deaeration module that deaerates the ink is provided on the ink supply path toward the ink ejection section. In the deaeration module, for example, a suction section connected to a gas permeable membrane via a vacuum path sucks air to decrease the pressure inside the gas permeable membrane. When the ink comes in contact with the outside of the gas permeable membrane the inside of which is depressurized, the gas permeable membrane selectively permeates the dissolved gas in the ink.

However, in the deaeration module, not only dissolved gas but also liquid components of the ink may pass through the gas permeable membrane. When the liquid components of the ink solidify in the vacuum path, the suction section cannot depressurize the gas permeable membrane. Further, when the liquid components of the ink reach the suction section, malfunction of the suction section may occur.

To address these issues, for example, Japanese unexamined patent application publication 2008-238127 describes a configuration in which a waste liquid tank is provided on the vacuum path to store the liquid components of the ink.

### SUMMARY OF THE INVENTION

However, in the configuration of JP2008-238127A, the liquid in the waste liquid tank needs to be removed periodically. Cleaning the waste liquid tank is time-consuming, and during the cleaning process, the image forming process cannot be performed. Therefore, even when the waste liquid tank is provided, it is preferable to minimize the amount of liquid components of the ink that pass through the gas permeable membrane. On the other hand, attempting to reduce the amount of liquid components of the ink that pass through the gas permeable membrane may cause other problems, such as a decrease in deaeration performance and clogging in the gas permeable membrane.

The present disclosure has been made in view of such circumstances. An object of the present disclosure is to provide a deaeration module and an inkjet recording apparatus capable of reducing the amount of liquid components that pass through a gas permeable membrane while maintaining performance of the deaeration module.

To achieve the abovementioned object, according to an aspect of the present invention, a deaeration module includes: a gas permeable membrane that selectively permeates a gas dissolved in ink, wherein: a ratio of an inner diameter of the gas permeable membrane to a membrane thickness of the gas permeable membrane is 3.2 or less, and the deaeration module removes the gas dissolved in the ink by an external recirculation method.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a side cross-sectional side view of an inkjet recording apparatus;

FIG. 2 is a block diagram of the inkjet recording apparatus;

FIG. 3 shows a schematic configuration diagram of the liquid delivery section of the inkjet recording apparatus;

FIG. 4 is a side cross-sectional view of a deaeration module;

FIG. 5 is a graph showing a relationship between the membrane thickness of a gas permeable membrane and a gas transmission rate;

FIG. 6 is a graph showing a relationship between the ratio of the inner diameter to the membrane thickness of the gas permeable membrane and the permeation amount of liquid components of the ink;

FIG. 7 is a graph showing a relationship between the membrane thickness of the gas permeable membrane and a deaeration rate of ink; and

FIG. 8 is a matrix table showing a list of preferred patterns of membrane thickness and inner diameter of the gas permeable membrane.

### DETAILED DESCRIPTION

Hereinafter, one or more embodiments of an inkjet recording apparatus according to the present invention will be described with reference to the drawings. However, the scope of the invention is not limited to the disclosed embodiments. In the following description, components having the same functions and configurations are denoted by the same reference numerals, and the description thereof will be omitted.

### [Overall Configuration of Inkjet Recording Apparatus]

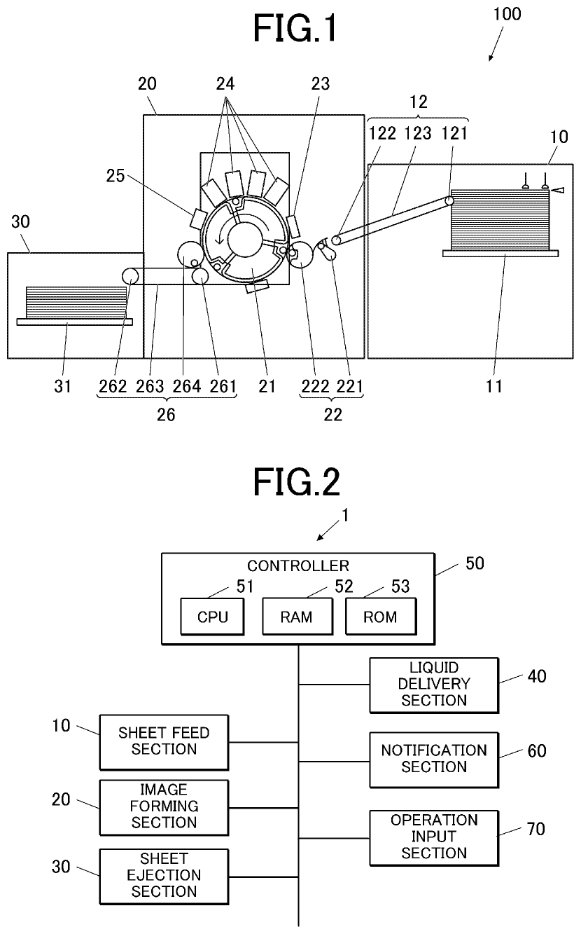

FIG. 1 is a side cross-sectional view of a main configuration of an inkjet recording apparatus 100. FIG. 2 is a block diagram showing a functional configuration of the inkjet recording apparatus 100. The inkjet recording apparatus 100 is equipped with, for example, a sheet feed section 10, an image forming section 20, a sheet ejection section 30, a liquid delivery section 40, a controller 50 (hardware processor), a notification section 60, and an operation input section 70.

The inkjet recording apparatus 100 conveys a recording medium from the sheet feed section 10 to the image forming section 20 under the control of the controller 50. The controller 50 causes the image forming section 20 to form an image on the recording medium with the ink supplied from the liquid delivery section 40. After the image formation, the controller 50 ejects the recording medium to the sheet ejection section 30.

### (Sheet Feed Section)

The sheet feed section 10 stores the recording medium before image formation. The sheet feed section 10 conveys the recording medium to the image forming section 20 under the control of the controller 50. The sheet feed section 10 includes a sheet feed tray 11 and a conveyance section 12.

### {Sheet Feed Tray}

The sheet feed tray 11 is a plate member that stores the recording medium. On the sheet feed tray 11, one or more recording media can be placed. The sheet feed tray 11 moves up and down according to the amount of the recording medium placed thereon. By such vertical movement, the sheet feed tray 11 is held at a position where the uppermost recording medium is conveyed by the conveyance section 12.

### {Conveyance Section}

The conveyance section 12 conveys the recording medium from the sheet feed tray 11 to the image forming section 20. The conveyance section 12 includes a conveyance mechanism. The conveyance mechanism drives a belt 123 to convey the recording medium on the belt 123. The belt 123 has a ring shape, and the inner side of the ring is supported by a plurality of rollers 121 and 122. The conveyance section 12 delivers the uppermost recording medium placed on the sheet feed tray 11 onto the belt 123 and conveys the recording medium along the belt 123.

### (Image Forming Section)

The image forming section 20 records an image on the recording medium P in cooperation with the liquid delivery section 40 under the control of the controller 50. The image forming section 20 includes an image forming drum 21, a handover unit 22, a sheet heating section 23, head units 24, an irradiation section 25, and a delivery section 26.

### {Image Forming Drum}

The image forming drum 21 conveys the recording medium along its cylindrical outer circumferential surface and conveys the recording medium with rotation. The conveyance surface of the image forming drum 21 faces the sheet heating section 23, the head unit 24, and the irradiation section 25, and performs an image forming process on the recording medium being conveyed.

### {Handover Unit}

The handover unit 22 is provided at a position between the conveyance section 12 and the image forming drum 21. The handover unit 22 includes a claw 221 and a handover drum 222.

The claw 221 is a cylindrical member that holds one end of the recording medium conveyed by the conveyance section 12. The handover drum 222 is a member that guides the recording medium held by the claw 221.

The handover unit 22 picks up the recording medium on the conveyance section 12 with the claw 221 and places the recording medium along the outer circumferential surface of the handover drum 222. By the operation, the handover unit 22 hands over the recording medium to the image forming drum 21.

### {Sheet Heating Section}

The sheet heating section 23 includes, for example, a heating wire and generates heat in response to energization. The sheet heating section 23 is controlled by the controller 50 to generate heat so that the recording medium passing in the vicinity of the sheet heating section 23 reaches a predetermined temperature. The sheet heating section 23 is provided in the vicinity of the outer circumferential surface of the image forming drum 21 and on the upstream side of the head units 24 in the conveyance direction of the recording medium P.

A temperature sensor (not illustrated) is provided near the sheet heating section 23. With the temperature sensor, the controller 50 senses a temperature around the sheet heating section 23. Based on the sensed temperature, the controller 50 controls heat generation of the sheet heating section 23.

### {Head Units}

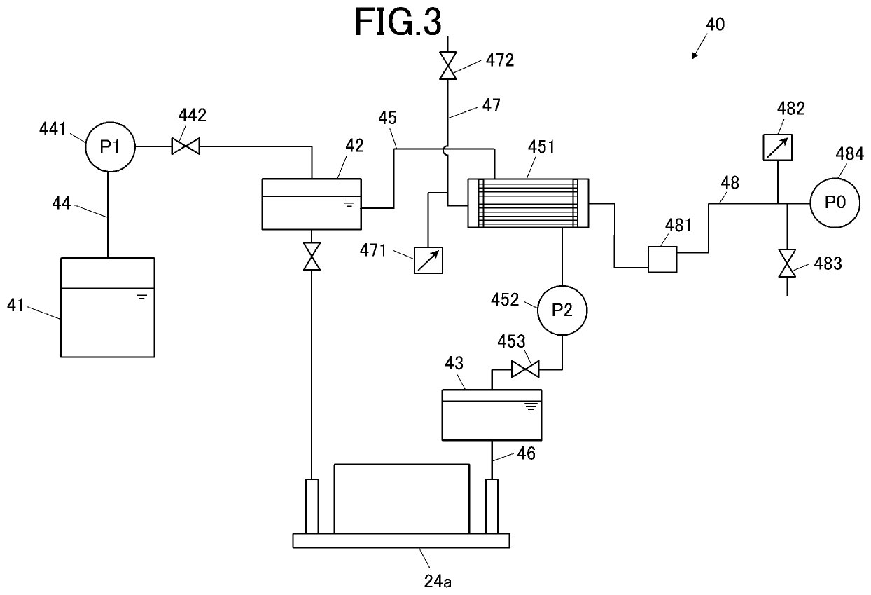

The head units 24 include, for example, multiple inkjet heads 24a (see FIG. 3). The head units 24 form images by ejecting ink droplets onto the recording medium from nozzles. The head units 24 corresponding to the respective colors of C (cyan), M (magenta), Y (yellow), and K (black) are provided. In FIG. 1, the head units 24 corresponding to the respective colors of Y, M, C, and K are provided in this order from the upstream in the conveyance direction of the recording medium.

Here, the direction perpendicular to the conveyance direction of the recording medium in plan view is referred to as a main scanning direction. The head units 24 have a length (width) in the main scanning direction that covers the entirety of the recording medium. That is, the inkjet recording apparatus 100 is a one-pass line-head type inkjet recording apparatus. The head units 24 have the multiple inkjet heads 24a arranged. There may be less than or more than four head units 24. Further, a single inkjet head 24a may constitute the head unit 24.

The ink ejected by the head units 24 is, for example, ultraviolet curable ink (UV ink). The ultraviolet curable ink contains, for example, an ultraviolet curable resin. The ultraviolet curable resin contains a monomer and a polymerization initiator. When the ink containing the ultraviolet curable resin is irradiated with ultraviolet rays, the monomer is polymerized and cured by the action of the polymerization initiator, and the ink is fixed to the recording medium.

The ink to be ejected by the head unit 24 may contain a gelling agent. The ink containing the gelling agent changes in phase between a gel state and a liquid (sol) state depending on the temperature. The ink containing the gelling agent has a phase change temperature of, for example, about 40 to 100° C., and is uniformly liquefied (solated) by being heated to the phase change temperature or higher. On the other hand, the ink containing the gelling agent is gelled at about normal room temperature, that is, about 0 to 30° C. Therefore, the ink in the head units 24 is heated to an appropriate temperature by an ink heater or the like (not illustrated) to be brought into a sol state. Then, after the ink is ejected and lands on the recording medium, the ink is moderately transferred to the gel state while the recording medium is conveyed by the image forming drum 21.

When the ink is the UV ink containing the gelling agent, the liquid components of the ink, the monomer, are likely to accumulate in a first trap 481, which is described below. The configuration of the present disclosure described below effectively deals with this.

### {Irradiation Section}

The irradiation section 25 includes, for example, a fluorescent tube such as a low-pressure mercury lamp. The irradiation section 25 emits energy rays such as ultraviolet rays by light emission of the fluorescent tube. The irradiation section 25 is provided near the outer peripheral surface of the image forming drum 21. The irradiation section 25 is positioned on the downstream side of the head unit 24 in the conveyance direction of the recording medium P. The irradiation section 25 irradiates the recording medium on which the ink has been ejected, with energy rays. When the ink on the recording medium is UV ink, the ink is cured by the action of the energy rays.

The fluorescent tube that emits ultraviolet rays is not limited to the low-pressure mercury lamp. The fluorescent tube may be a mercury lamp having an operating pressure of a few hundred Pa to 1 MPa, for example. The fluorescent tube may be a light source usable as a bactericidal lamp, for example, a cold-cathode tube, an ultraviolet laser light source, a metal halide lamp, a light-emitting diode, or the like. The fluorescent tube is desirably a power saving light source capable of emitting ultraviolet rays with higher illuminance. The fluorescent tube is, for example, the light-emitting diode. The energy rays are not limited to the ultraviolet rays and may be energy rays having a property of curing the ink depending on the property of the ink. The light source is replaced depending on the energy rays.

In the above description, the head unit 24 ejects the ultraviolet curable ink or the ink containing the gelling agent as an example. However, the invention is not limited thereto. The ink ejected by the head unit 24 may be water-based ink or ink having other physical properties.

### {Delivery Section}

The delivery section 26 includes a conveyance mechanism. The conveyance mechanism drives a ring-shaped belt 263 the inside of which is supported by a plurality of rollers 261 and 262 to convey the recording medium. The delivery section 26 includes a cylindrical handover roller 264. The handover roller 264 hands over the recording medium from the image forming drum 21 to the conveyance mechanism. The delivery section 26 conveys the recording medium delivered onto the belt 263 by the handover roller 264 and sends the recording medium to the sheet ejection section 30.

### (Sheet Ejection Section)

The recording medium on which the image has been formed by the image forming section 20 is ejected to the sheet ejection section 30. The sheet ejection section 30 includes a plate-shaped sheet ejection tray 31. The recording medium sent from the image forming section 20 by the delivery section 26 is placed on the sheet ejection tray 31. The sheet ejection section 30 stores the recording medium until the user takes out the recording medium.

### (Liquid Delivery Section)

FIG. 3 shows a schematic configuration diagram of the liquid delivery section 40. The liquid delivery section 40 includes multiple main tanks 41 that store the respective colors of ink. The liquid delivery section 40 supplies the ink of each color in the main tank 41 to the inkjet head 24a of each head unit 24. According to such control, the liquid delivery section 40 allows the ink of each color to be dischargeable from the nozzles.

As illustrated in FIG. 3, the liquid delivery section 40 includes the main tank 41, a first sub-tank 42, and a second sub-tank 43. In addition, the liquid delivery section 40 includes a deaeration module 451 that removes gases dissolved in the ink before supplying the ink to the head unit 24.

### <Main Tank>

The main tank 41 stores ink to be supplied to each part of the liquid delivery section 40. The main tank 41 is, for example, a rigid sealed tank made of metal. The main tank 41 is connected to the first sub-tank 42 via a supply pipe 44.

### <First Sub-Tank>

The first sub-tank 42 is one or more ink inflow chambers with a smaller volume than the main tank 41. The ink pumped out of the main tank 41 by the supply pump 441 is stored in the first sub-tank 42. Providing the first sub-tank 42 alleviates the pressure fluctuation caused by pulsation when the supply pump 441 supplies the ink from the main tank 41. The first sub-tank 42 is connected to the second sub-tank 43 via a liquid delivery pipe 45.

The ink that has not been discharged from the inkjet head 24a is collected in the first sub-tank 42 via a circulation channel that connects the outlet of the inkjet head 24a to the first sub-tank 42. With such a circulation channel, during maintenance, the ink is circulated from the first sub-tank 42 through the deaeration module 451, so that the gasses dissolved in the ink can be removed.

The circulation channel may not pass through the inkjet head 24a. For example, the circulation channel may be a channel that connects a point downstream of a liquid delivery pump 452 and upstream of a liquid delivery valve 453 (both described below) of the liquid delivery pipe 45 with the first sub-tank 42.

### <Second Sub-Tank>

The second sub-tank 43 is a small tank chamber in which ink degassed by the deaeration module 451 is temporarily stored. The capacity of the second sub-tank 43 is substantially the same as that of the first sub-tank 42, for example. The second sub-tank 43 is connected to the inlet of the inkjet head 24a via a supply path 46. The ink in the second sub-tank 43 is supplied to the inkjet head 24a, based on the amount of ink ejected from the nozzles.

The second sub-tank 43 is provided with a known back pressure adjustment means (not illustrated). The back pressure adjustment means applies an appropriate negative pressure to the inkjet head 24a to prevent leakage of ink from the nozzles of the inkjet head 24a.

### <Supply Pipe>

The supply pipe 44 is an ink channel that connects the main tank 41 and the first sub-tank 42. The supply pipe 44 is provided with a supply pump 441 and a supply valve 442. The supply pump 441 and the supply valve 442 operate under the control of the controller 50. The ink in the main tank 41 is supplied to the first sub-tank 42 via the supply pipe 44 by driving the supply pump 441 when the supply valve 442 is opened. The entire main tank 41 is replaceable. Further, the main tank 41 can be attached to and detached from the supply pipe 44 regardless of the driving state of the supply pump 441.

### <Liquid Delivery Pipe>

The liquid delivery pipe 45 is an ink channel that connects the first sub-tank 42 and the second sub-tank 43. The liquid delivery pipe 45 is provided with the deaeration module 451, the liquid delivery pump 452, the liquid delivery valve 453, and so forth.

### <Deaeration Module>

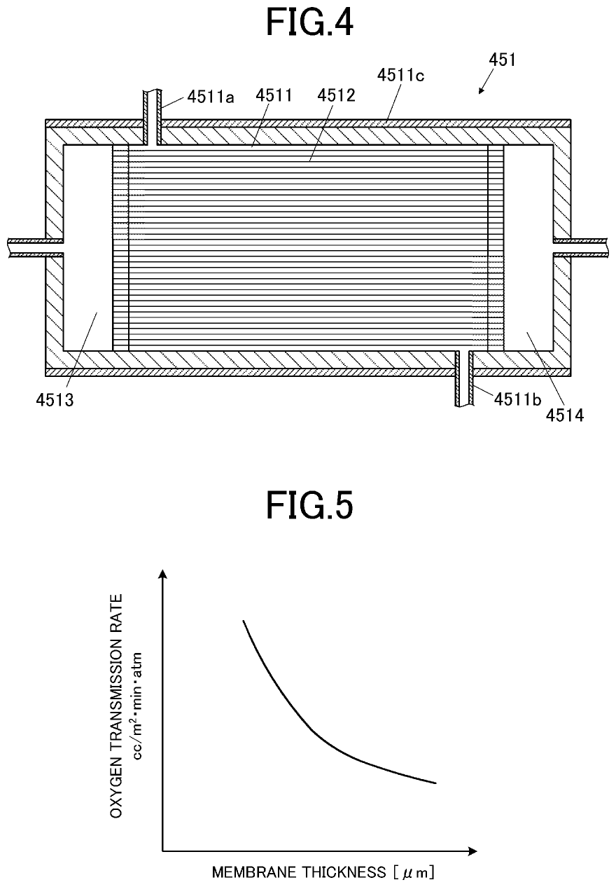

FIG. 4 illustrates an enlarged cross-sectional view of the deaeration module 451. The deaeration module 451 removes gases dissolved in the ink having flowed into the module 451 and ejects the deaerated ink. The deaeration module 451 includes an ink flow chamber 4511, a gas permeable membrane 4512, a first vacuum chamber 4513, and a second vacuum chamber 4514.

### {Ink Flow Chamber}

The ink flow chamber 4511 is provided at the central part inside the casing of the deaeration module 451. The ink flow chamber 4511 includes an ink inflow port 4511a and receives inflow of the ink before deaeration from the first sub-tank 42. The ink flow chamber 4511 also includes an ink outflow port 4511b, and the deaerated ink flows out to the second sub-tank 43.

As illustrated in FIG. 4, the ink inflow port 4511a and the ink outflow port 4511b are preferably provided on a first end side and a second end side opposite the first end side of the ink flow chamber 4511, respectively. In particular, as illustrated in FIG. 4, it is more preferable that the ink inflow port 4511a and the ink outflow port 4511b are provided on a substantially diagonal line of the ink flow chamber 4511. With this configuration, the ink more readily comes into contact with the gas permeable membrane 4512, thereby increasing the deaeration efficiency of the deaeration module 451.

A heat source 4511c (heater) that is heated under the control of the controller 50 is provided on the periphery of the ink flow chamber 4511. The ink in the ink flow chamber 4511 is heated by the heat supplied by the heat source 4511c to a temperature range of 65 to 85° C., and the viscosity is controlled to be in the range of 5 to 10 mPa·s.

### {Gas Permeable Membrane}

The gas permeable membrane 4512 is tubular, and the surface of the gas permeable membrane 4512 is gas permeable. The gas permeable membrane 4512 is, for example, a hollow fiber membrane, includes a plurality of hollow fine fiber structures, and is disposed such that the plurality of hollow fine fiber structures is bundled and extends in an axial direction of the ink flow chamber 4511.

Further, as shown in FIG. 4, the gas permeable membrane 4512 is disposed so as to connect the first vacuum chamber 4513 and the second vacuum chamber 4514. Accordingly, a first end of the gas permeable membrane 4512 is connected to the atmosphere via a first vacuum path 47 as described later. Further, a second end of the gas permeable membrane 4512 opposite the first end is subjected to suction by a vacuum pump 484 via a second vacuum path 48 as described later.

A preferred detailed configuration of the gas permeable membrane 4512 will be described later.

### {First Vacuum Chamber}

The first vacuum chamber 4513 is provided at the first end of the deaeration module 451. The first vacuum chamber 4513 is formed by being partitioned from the ink flow chamber 4511 by a partition wall. The first vacuum chamber 4513 is connected to the atmosphere by the first vacuum path 47 on the side opposite the ink flow chamber 4511.

### {Second Vacuum Chamber}

The second vacuum chamber 4514 is provided at the second end opposite the first vacuum chamber 4513 of the deaeration module 451. The second vacuum chamber 4514 is formed by being partitioned from the ink flow chamber 4511 by a partition wall. A side of the second vacuum chamber 4514 opposite the ink flow chamber 4511 is in communication with the vacuum pump 484 via a second vacuum path 48.

Although the configuration of the deaeration module 451 is not particularly limited, it is preferable that the module is a sheet in which a plurality of gas permeable membranes 4512 are interwoven into a mesh pattern, for example. With such a configuration, pores of the gas permeable membrane 4512 become fine, all the ink easily passes through the pores of the gas permeable membrane 4512, and the deaeration efficiency is easily increased. Furthermore, with such a configuration, even a flexible gas permeable membrane 4512 can have a certain strength or more.

### <Liquid Delivery Pump, Liquid Delivery Valve>

Returning to FIG. 3, the liquid delivery pump 452 and the liquid delivery valve 453 operate under the control of the controller 50. The liquid delivery pump 452 delivers ink discharged from the ink outlet port 4511b of the deaeration module 451 to the second sub-tank 43 when the liquid delivery valve 453 is open. A check valve (not shown) is provided between the liquid delivery pump 452 and the second sub-tank 43 to prevent backflow of ink delivered to the second sub-tank 43.

### <First Vacuum Path>

The first vacuum path 47 is an air channel that communicates with the first end of the deaeration module 451. The first vacuum path 47 is provided with a first pressure sensor 471 and a hollow fiber valve 472.

### <First Pressure Sensor>

The first pressure sensor 471 is a known pressure gauge. The first pressure sensor 471 detects a pressure value in the first vacuum chamber 4513 and sends the pressure value to the controller 50.

### <Hollow Fiber Valve>

Hollow fiber valve 472 is a solenoid valve. Hollow fiber valve 472 opens or closes the first vacuum path 47 to atmosphere by control signals from the controller 50.

### <Second Vacuum Path>

The second vacuum path 48 is an air channel communicating with the second end of the deaeration module 451. The second vacuum path 48 is provided with a first trap 481, a second pressure sensor 482, an atmospheric relief valve 483, and a vacuum pump 484.

### <First Trap>

The first trap 481 is provided between the deaeration module 451 and the vacuum pump 484. The first trap 481 stores liquid components of ink that have infiltrated into the gas permeable membrane 4512 and entered the second vacuum path 48. For example, when the ink is a UV ink, the liquid component of the ink stored by the first trap 481 is a monomer. The first trap 481 prevents the liquid components of the ink from reaching the vacuum pump 484 and causing malfunction of the vacuum pump 484.

### <Second Pressure Sensor>

The second pressure sensor 482 is a known pressure gauge. The second pressure sensor 482 is installed between the first trap 481 and the vacuum pump 484 in the second vacuum path 48, detects the pressure value in the second vacuum path 48, and successively transmits the detected pressure value to the controller 50.

### <Atmospheric Relief Valve>

The atmospheric relief valve 483 is a solenoid valve that can be opened and closed under the control of the controller 50. The atmospheric release valve 483 is provided between the first trap 481 and the vacuum pump 484 and is opened when the second vacuum path 48 is connected to the atmosphere.

### <Vacuum Pump>

The vacuum pump 484 is, for example, a diaphragm pump. Specifically, the vacuum pump 484 includes a pump chamber having an extendable diaphragm. In addition, the vacuum pump 484 includes a driving source or the like that operates the diaphragm so that the volume of the pump chamber expands and contracts. The pump chamber includes a suction port having a check valve that allows only inflow of fluid from the outside. The pump chamber also includes a discharge port having a check valve that allows only outflow of fluid from the inside.

Under the control of the controller 50, the vacuum pump 484 suctions the inside of the gas permeable membrane 4512 by performing a suction operation when the hollow fiber valve 472 is opened. By this operation of the vacuum pump 484, foreign substances in the gas permeable membrane 4512 are removed, and the gas permeable membrane 4512 is depressurized. At this time, the pressure difference between the inside and the outside of the gas permeable membrane 4512 is controlled to be 80 kPa or greater. The ink flowing into the ink flow chamber 4511 and coming into contact with the outer membrane surface of the gas permeable membrane 4512 is deaerated as the membrane surface selectively permeates the dissolved gas. The dissolved gas having passed through the gas permeable membrane 4512 is discharged by the vacuum pump 484 via the second vacuum chamber 4514.

### (Controller)

Returning to FIG. 2, the controller 50 is connected to each component of the inkjet recording apparatus 100. The controller 50 controls each component of the inkjet recording apparatus 100. The controller 50 includes a central processing unit (CPU) 51, a random-access memory (RAM) 52, and a read-only memory (ROM) 53.

### <CPU>

The CPU 51 reads various programs and data corresponding to processing contents from a storage device, such as the ROM 53, and executes the programs. The CPU 51 controls operations of the components constituting the inkjet recording apparatus 100 according to the contents of the executed processing. When the CPU 51 executes the programs, the controller 50 functions as a heat controller that controls the heat source 4511c as described above.

### <RAM>

The RAM 52 temporarily stores various programs and data processed by the CPU 51.

### <ROM>

The ROM 53 is a non-volatile storage section, such as a hard disk drive (HDD), solid state drive (SSD), or flash memory. The ROM 53 stores various programs and data to be read by the CPU 51.

### (Notification Section)

Under the control of the controller 50, the notification section 60 provides various kinds of information. The notification section 60 is, for example, a display with a screen, a speaker that outputs a predetermined sound, or a communication section that can communicate with other devices via a network.

### (Operation Input Section)

The operation input section 70 receives various inputs by the user related to the operation of the inkjet recording apparatus 100. The operation input section 70 includes, for example, a touch screen-type input display device and/or various function keys and arrow keys such as up, down, left, and right keys for data selection and feed operation. The operation input section 70 outputs, to the CPU 51 of the controller 50, a key press signal of a key pressed by the user or an operation signal from a mouse, for example.

### [Detailed Configuration of Deaeration Module]

Hereinafter, a preferred detailed configuration of the deaeration module 451 will be described, with a focus on the gas permeable membrane 4512.

### (Structure of Gas Permeable Membrane)

The gas permeable membrane 4512 is preferably made of nonporous material. Nonporous means that the porosity is extremely low, specifically less than 20%. The gas permeable membrane 4512 made of nonporous material can restrain penetration of liquid components of the ink into the gas permeable membrane 4512.

Examples of nonporous material include silicone, polymethylpentene, and certain polytetrafluoroethylene materials. It is preferable that the gas permeable membrane 4512 is made of silicone. This is because silicone has a high ability to transmit the dissolved gas in the ink. Further, silicone has high heat resistance and ink resistance.

### (Ratio of Inner Diameter to Membrane Thickness of Gas Permeable Membrane)

As described above, the vacuum pump 484 performs the suction operation when the hollow fiber valve 472 is opened to evacuate the inside of the gas permeable membrane 4512, remove foreign substances from the inside of the gas permeable membrane 4512, and depressurize the inside of the gas permeable membrane 4512. At this time, the gases dissolved in ink in contact with the outer membrane surface of the gas permeable membrane 4512 in the ink flow chamber 4511 selectively pass through the membrane surface and are thereby removed.

In the deaeration process performed by the deaeration module 451, not only the dissolved gas in the ink but also the liquid components of the ink may pass through the membrane surface of the gas permeable membrane 4512. Since the second vacuum path 48 is equipped with the first trap 481, the liquid component of the ink can be prevented from coagulating in the second vacuum path 48 or reaching the vacuum pump 484 and causing malfunction of the vacuum pump 484. However, the liquid component of the ink accumulated in the first trap 481 must be removed each time its amount reaches a predetermined level. At the time of removing the liquid component, the image formation process needs to be interrupted. In consideration of productivity, it is preferable that the liquid component of the ink be prevented as much as possible from passing through the membrane surface of the gas permeable membrane 4512, flowing inside the gas permeable membrane 4512, and reaching the first trap 481.

The liquid component of the ink penetrates the gas permeable membrane 4512, based on the concentration difference between the inside and the outside of the gas permeable membrane 4512. Specifically, the greater the concentration difference between the inside and the outside of the gas permeable membrane 4512 is, the more easily the liquid component of the ink penetrates into the gas permeable membrane 4512. The concentration difference between the inside and the outside of the gas permeable membrane 4512 decreases as the membrane thickness of the gas permeable membrane 4512 increases. Further, when the inner diameter of the gas permeable membrane 4512 is small, the liquid component of the ink having entered the gas permeable membrane 4512 is less likely to move, so that the concentration difference between the inside and the outside of the gas permeable membrane 4512 decreases.

Therefore, to suppress the liquid component of the ink from reaching the first trap 481, it is preferable that the membrane thickness of the gas permeable membrane 4512 be increased and that the inner diameter thereof be decreased. In other words, it is preferable that the ratio of the inner diameter to the membrane thickness (inner diameter/membrane thickness) be as small as possible.

On the other hand, as is generally known, excessively increasing the membrane thickness of the gas permeable membrane 4512 decreases gas permeability and thereby decreases deaeration performance, as shown in FIG. 5. In the graph of FIG. 5, the horizontal axis indicates the membrane thickness, and the vertical axis indicates the oxygen transmission rate.

Further, excessively decreasing the inner diameter of the gas permeable membrane 4512 may cause clogging therein. When clogging occurs in the gas permeable membrane 4512, the inside of the gas permeable membrane 4512 cannot be depressurized, and the gas permeable membrane 4512 cannot perform deaeration. Therefore, the gas permeable membrane 4512 needs to be replaced.

To reduce the amount of liquid component permeating through the gas permeable membrane 4512 while maintaining performance of the deaeration module 451, the ratio of the inner diameter to the membrane thickness of the gas permeable membrane 4512 should not be excessively decreased but should be determined appropriately. The following tests 1 to 3 were conducted to appropriately determine the ratio of the inner diameter to the membrane thickness of the gas permeable membrane 4512.

[Test 1. Preferable Range of Inner Diameter for Film Thickness of 100 μm]

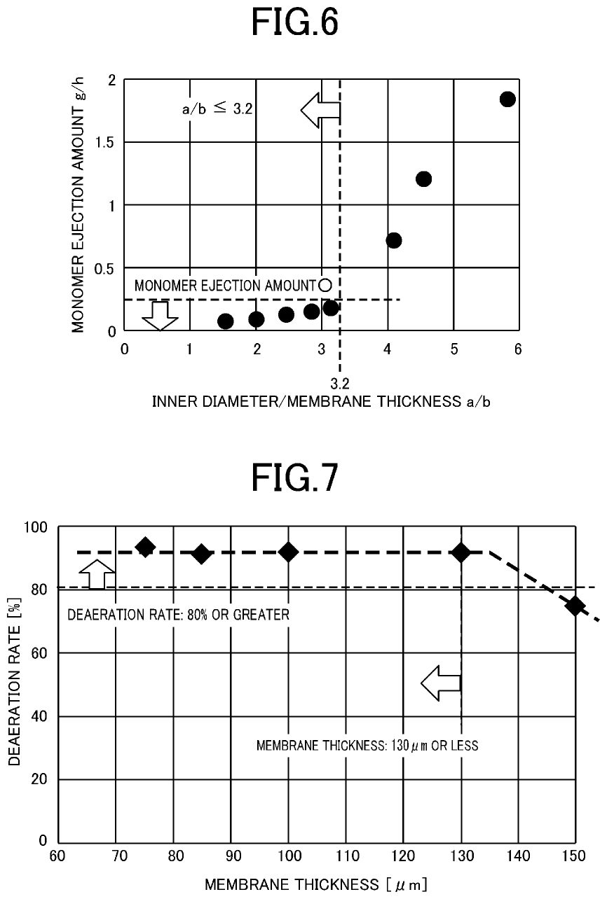

Deaeration modules 451 each having the gas permeable membrane 4512 were prepared. The average membrane thickness of each gas permeable membrane 4512 was fixed at 100 μm, whereas the average inner diameters of the respective gas permeable membranes 4512 were appropriately set in a range of 150 μm to 600 μm. The ink temperature was set in the range of 65 to 85° C. and the viscosity in the range of 5 to 10 mPa·s, and the deaeration modules 451 were operated for 100 hours while the pressure difference between the inside and the outside of the gas permeable membrane 4512 was kept at 80 kPa or greater. After 100 hours, the amount of the liquid component of the ink stored in the first trap 481 was measured for each deaeration module 451. The results of Test 1 are shown in FIG. 6. In the graph of FIG. 6, the horizontal axis represents the ratio of the inner diameter to the membrane thickness of the gas permeable membrane 4512, and the vertical axis represents the amount of the ejected liquid component of the ink (monomer in this example).

As shown in FIG. 6, when the average membrane thickness of the gas permeable membrane 4512 was set to 100 μm and the average inner diameter was 320 μm or less, no significant difference was observed in the amount of the ejected liquid component of the ink. On the other hand, when the average value of the inner diameter was greater than 320 μm, the amount of the ejected liquid component of the ink greatly increased.

### [Test 2. Preferable Range of Ratio of Film Thickness to Inner Diameter]

Based on Test 1, deaeration modules 451 each having a gas permeable membrane 4512 were prepared. The average membrane thickness of each of the gas permeable membranes 4512 was set to one of 70 μm, 100 μm, and 130 μm, and the average inner diameter thereof was set to one of 200 μm, 320 μm, and 410 μm. The deaeration modules 451 were operated under the same conditions as in Test 1, and the amount of the liquid component (a monomer in this example) of the ink stored in the first trap 481 was measured for each deaeration module 4512. The results of Test 2 are shown in Table I.

TABLE I

| INNER | MEMBRANE | | MONOMER |
|---|---|---|---|
| DIAMETER | THICKNESS | | EJECTION |
| a [μm] | b [μm] | a/b | AMOUNT [g/h] |
| 200 | 70 | 2.86 | 0.154 |
| 320 | 70 | 4.57 | 1.21 |
| 410 | 70 | 5.86 | 1.84 |
| 200 | 100 | 2.00 | 0.089 |
| 320 | 100 | 3.20 | 0.195 |
| 410 | 100 | 4.10 | 0.72 |
| 200 | 130 | 1.54 | 0.083 |
| 320 | 130 | 2.46 | 0.132 |
| 410 | 130 | 3.15 | 0.181 |

As shown in Table I, when the average membrane thickness of the gas permeable membrane 4512 was set to 70 μm, the monomer ejection amount increased significantly with the average inner diameter of 320 μm, unlike the case where the average membrane thickness was set to 100 μm. On the other hand, when the average membrane thickness of the gas permeable membrane 4512 was set to 130 μm, the monomer ejection amount did not increase significantly with the average inner diameter of 410 μm.

Tests 1 and 2 show that the amount of the ejected liquid component of ink in the first trap 481 increases rapidly when the ratio of the inner diameter to the membrane thickness of the gas permeable membrane 4512 exceeds 3.2, rather than depending on the absolute value of the inner diameter. Therefore, it is preferable that the ratio of the inner diameter to the membrane thickness of the gas permeable membrane 4512 be at least 3.2 or less.

### [Test 3. Upper Limit of Membrane Thickness]

The deaeration modules 451 equipped with gas permeable membranes 4512 were prepared. The average inner diameter of each gas permeable membrane 4512 was fixed at 200 μm, and the average membrane thickness was appropriately set within a range of 60 to 150 μm. The ink temperature was set in the range of 65 to 85° C. and the viscosity in the range of 5 to 10 mPa·s, and the deaeration modules 451 were operated for 3000 hours while the pressure difference between the inside and the outside of the gas permeable membrane 4512 was kept at 80 kPa or greater. Then the deaeration rate was measured. The deaeration rate was calculated, based on the following formula (1).

Deaeration rate (%)=[(The amount of dissolved gas in ink before passing through the deaeration module 451)−(The amount of dissolved gas in ink after passing through the deaeration module 451)]/(The amount of dissolved gas in ink before passing through the deaeration module 451)×100 (1)

The results of Test 3 are shown in FIG. 7. In the graph of FIG. 7, the horizontal axis represents the membrane thickness of the gas permeable membrane 4512, and the vertical axis represents the deaeration rate of the ink. As described above, in general, as the membrane thickness of the gas permeable membrane 4512 increases, gas permeability decreases and deaeration performance decreases. However, the deaeration rate of the deaeration module 451 did not decrease even when the average membrane thickness was increased up to 130 μm, and the deaeration rate of the deaeration module 451 decreased when the average membrane thickness exceeded 130 μm. From the above, it is preferable that the average membrane thickness of the gas permeable membrane 4512 be 130 μm or less.

In the following, “(the average inner diameter of the gas permeable membrane)/(the average membrane thickness)<3.2” derived from Tests 1 and 2 is referred to as “Condition 1”. Further, “(the average membrane thickness of the gas permeable membrane)<130 μm” derived from Test 3 is referred to as “Condition 2”. To satisfy the conditions 1 and 2, it can be understood that the average inner diameter of the gas permeable membrane 4512 needs to be 410 μm or less (hereinafter referred to as “Condition 3”).

Regarding the lower limit of the inner diameter and the membrane thickness of the gas permeable membrane 4512, it is preferable that the average membrane thickness be 70 μm or greater. This is because the gas permeable membrane 4512 having the average membrane thickness less than 70 μm may not be sufficiently strong and may have pinholes, which can cause ink leakage inside the membrane 4512. Such a limitation is added to Condition 2: “70 μm<(the average membrane thickness of the gas permeable membrane)<130 μm”, which is referred to as Condition 2a. Further, when the average inner diameter is less than 200 μm, the ink tends to clog inside. It is therefore preferable that the average inner diameter be 200 μm or greater. Such a limitation is added to Condition 3: “200 μm<(the average inner diameter of the gas permeable membrane)<410 μm”, which is referred to as Condition 3a.

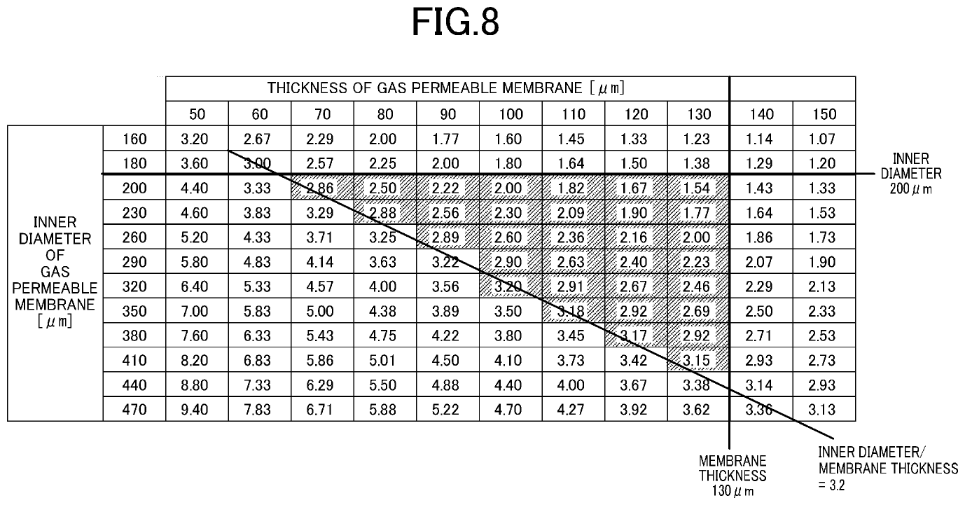

FIG. 8 shows a matrix table showing the ranges of the membrane thickness and the inner diameter of the gas permeable membrane 4512 that satisfy the above-described conditions 1, 2a, and 3a. Each value in FIG. 8 indicates the ratio of the inner diameter to the membrane thickness of the gas permeable membrane 4512.

### (Deaeration Method)

The deaeration module 451 is roughly classified into (i) an external recirculation type that removes dissolved gas from ink in contact with the outer surface of the gas permeable membrane 4512 and (ii) an internal recirculation type that removes dissolved gas from ink flowing inside the gas permeable membrane 4512. The external recirculation type is preferable.

As described above, to restrain penetration of the liquid component of ink into the gas permeable membrane 4512, it is preferable to increase the membrane thickness of the gas permeable membrane 4512 to reduce the concentration difference between the inside and the outside of the gas permeable membrane 4512. On the other hand, reducing the concentration difference between the inside and outside of the gas permeable membrane 4512 is likely to decrease gas permeability.

Since the external recirculation type deaeration module 451 has an increased membrane thickness of the gas permeable membrane 4512, the deaeration module 451 also has an increased outer surface area that is to be in contact with the ink. This can offset a decrease in gas permeability caused by the increased membrane thickness of the gas permeable membrane 4512.

On the other hand, with respect to an internal recirculation type deaeration module 451 that deaerates the ink inside the gas permeable membrane 4512, increasing the membrane thickness of the gas permeable membrane 4512 does not change the inner surface area that is to be in contact with the ink. Therefore, increasing the membrane thickness of the gas permeable membrane 4512 may simply decrease the gas permeability.

### Effects of Embodiment

As described above, the deaeration module 451 according to the present embodiment includes the gas permeable membrane 4512 that selectively permeates the gas dissolved in the ink. The ratio of the inner diameter to the membrane thickness of the gas permeable membrane 4512 is 3.2 or less. The deaeration module 451 deaerates the gas dissolved in the ink by an external recirculation method. With this configuration, the amount of the liquid component that passes through the gas permeable membrane 4512 can be reduced, while the performance of the deaeration module 451 is maintained.

Further, according to the deaeration module 451 of the present embodiment, the average inner diameter of the gas permeable membrane 4512 is 200 μm or greater. With this configuration, occurrence of clogging in the gas permeable membrane 4512 can be suppressed.

Further, according to the deaeration module 451 of the present embodiment, the average membrane thickness of the gas permeable membrane 4512 is 70 μm or greater and 130 μm or less. With this configuration, both durability and deaeration performance of the deaeration module 451 can be achieved.

Further, according to the deaeration module 451 of the present embodiment, the porosity of the gas permeable membrane 4512 is less than 20%. With this configuration, it is possible to suppress permeation of the liquid component of the ink into the gas permeable membrane 4512.

The scope of the present disclosure is not limited to the embodiment described above but includes the scope of the invention described in the claims and their equivalents. Although embodiments of the present invention have been described and illustrated in detail, the disclosed embodiments are provided for purposes of illustration and example only and not limitation. The scope of the present invention should be construed in accordance with the terms of the appended claims.

What is claimed is:

1. A deaeration module comprising:
a gas permeable membrane that selectively permeates a gas dissolved in ink, wherein:
a ratio of an inner diameter of the gas permeable membrane to a membrane thickness of the gas permeable membrane is 3.2 or less, and
the deaeration module removes the gas dissolved in the ink by an external recirculation method.

2. The deaeration module according to claim 1, wherein an average inner diameter of the gas permeable membrane is 200 μm or greater.

3. The deaeration module according to claim 2, wherein an average membrane thickness of the gas permeable membrane is 70 μm or greater and 130 μm or less.

4. The deaeration module according to claim 1, wherein a porosity of the gas permeable membrane is less than 20%.

5. An inkjet recording apparatus comprising:
a liquid delivery section including the deaeration module according to claim 1; and
an inkjet head that ejects the ink delivered by the liquid delivery section.

6. The inkjet recording apparatus according to claim 5, wherein:
the liquid delivery section includes a vacuum path through which the gas removed from the ink by the deaeration module flows,
the vacuum path includes a vacuum pump, and
the vacuum pump depressurizes an inside of the gas permeable membrane so that a pressure difference between the inside and an outside of the gas permeable membrane is 80 kPa or greater.

7. The inkjet recording apparatus according to claim 5, further comprising a heater that heats the ink to a temperature between 65° C. and 85° C. inclusive.

8. The inkjet recording apparatus according to claim 7, wherein a viscosity of the ink heated by the heater is between 5 mPa·s and 10 mPa·s inclusive.

9. The inkjet recording apparatus according to claim 5, wherein:
the liquid delivery section includes a vacuum path through which the gas removed from the ink by the deaeration module flows,
the vacuum path includes an atmospheric relief valve capable of opening the vacuum path to the atmosphere, and
the inkjet recording apparatus further includes a hardware processor that opens the atmospheric relief valve at a predetermined timing so that the gas permeable membrane ejects a liquid component in the gas permeable membrane.

10. The inkjet recording apparatus according to claim 5, wherein the inkjet head ejects the ink containing a gelling agent.
